(19) United States
(12) Patent Application Publication
(10) Pub. No.: US 2017/0039026 A1
(43) Pub. Date: Feb. 9, 2017

(54) Auditory Transition System

(71) Applicant: Ruben Valas, San Diego, CA (US)

(72) Inventor: Ruben Valas, San Diego, CA (US)

(21) Appl. No.: 15/225,087

(22) Filed: Aug. 1, 2016

Related U.S. Application Data
(60) Provisional application No. 62/201,200, filed on Aug. 5, 2015.

(51) Int. Cl. G06F 3/16; G06F 17/30

(52) U.S. Cl. CPC G06F 3/165; G06F 3/162; G06F 17/30761; G06F 17/30778

(57) ABSTRACT

An auditory transition system may consist of an audio processor electrically connected between a memory and a speaker. The audio processor can insert a first auditory transition between first and second audio segments so that the first audio segment and second audio segment are continuously played from the speaker without an audible seam.

### RELATED APPLICATION

The present application makes a claim of domestic priority to U.S. Provisional Patent Application No. 62/201,200 filed Aug. 5, 2015, the contents of which are hereby incorporated by reference.

### SUMMARY OF THE INVENTION

An auditory transition system can, in some embodiments, have an audio processor connected between a memory and a speaker. The audio processor can insert a first auditory transition between first and second audio segments so that the first audio segment and second audio segment are continuously played from the speaker without an audible seam.

### BRIEF DESCRIPTION OF THE DRAWINGS

FIG. 1 provides a block representation of an example auditory transition system arranged in accordance with some embodiments.

FIG. 2 displays a block representation of a portion of an example auditory transition system configured in accordance with various embodiments.

FIG. 3 depicts a graphical representation of portions of an example auditory transition system constructed and operated in accordance with assorted embodiments.

FIG. 4 is a directed graph representing an example collection of transitions that may be utilized in the auditory transition system of FIG. 1.

FIG. 5 shows example transition traversals that may be employed in the auditory transition system of FIG. 1.

FIG. 6 illustrates portions of an example transition between two songs in accordance with some embodiments.

FIG. 7 conveys an example user interface console suitable for the auditory transition system of FIG. 1.

### DETAILED DESCRIPTION

Various embodiments are generally directed to structures that provide transitions between audio recordings, such as transitions between songs.

With the proliferation of auditory content, such as music and spoken word performances, a user can enjoy hours of playback. The recent advancement of mobile data generation, transmission, and playback has increased the amount of auditory content being played. However, seams, pauses, and unintelligent transitions between auditory tracks can be displeasing to a user and degrade the auditory listening experience. Accordingly, assorted embodiments are directed to structures that intelligently transition between different segments of auditory content to enhance the auditory experience of a user without audible seams, pauses in audible signal, or abrupt disconnected auditory jumps.

While various types of systems can determining the order of playback of a series of audio files for a user, such as random selections and selections predicted to be preferred by the user, a transition between songs in such systems may abrupt and unpleasant. It is noted that the use of a predetermined transition pattern between songs may also be audibly unpleasant. The order of playback of a series of audio files and transitions may, in some embodiments, be created on-the-fly by a human, such as a disc jockey (dj), but talent, timing, and equipment can be limiting factors for the repetition of pleasant auditory transitions. Hence, it is a continued goal to provide auditory transitions that are pleasant to a user while being repeatable and adaptable to different environments and situations.

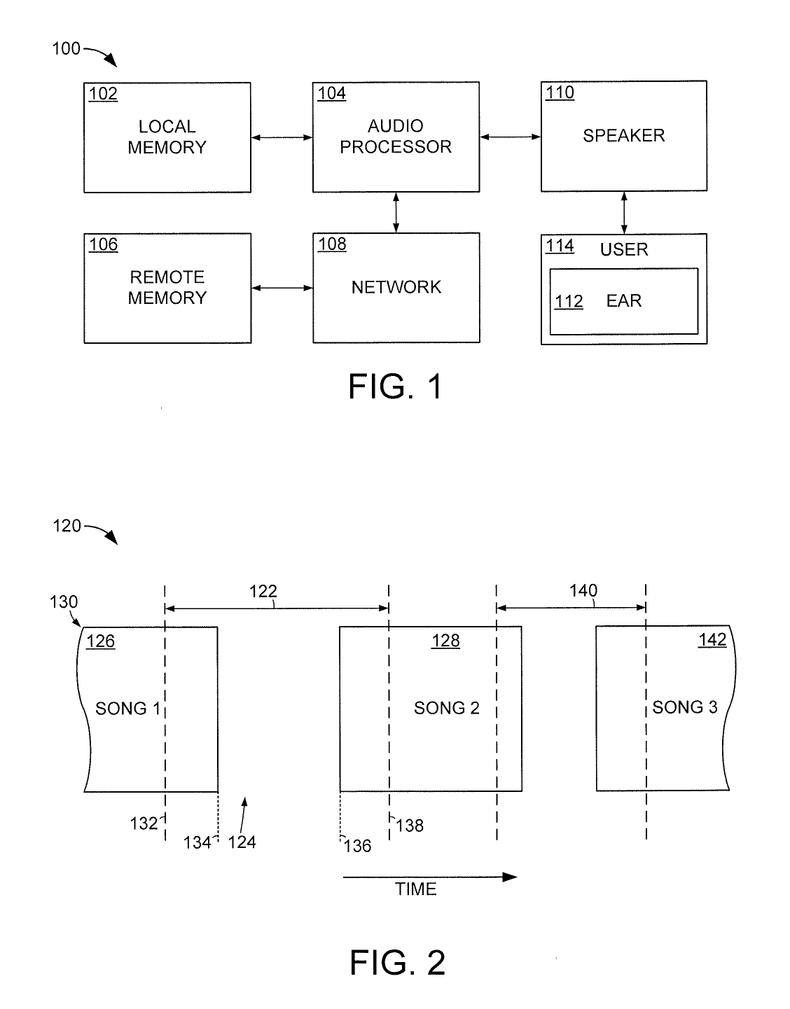

FIG. 1 displays a block representation of an example auditory transition system 100 arranged in accordance with some embodiments. The system 100 can generate and apply one or more auditory transitions to an audible playback stream with any number of local and/or remotely located hosts. In the non-limiting example of FIG. 1, a local memory 102 is connected to an audio processor 104 along with a remote host 106. The remote host 106 can be a memory, controller, node, or server that can provide, and retrieve, data to the audio processor 104 via a wired or wireless network 108.

The audio processor 104 can provide audio signal generation, alteration, processing, and amplification capabilities, as directed by at least one microprocessor locally positioned in the audio processor 104. One or more speakers 110 can receive and translate audio signals from the audio processor 104 into audible and inaudible frequencies, such as 1-50,000 Hz, that can be heard by the ear 112 of a user 114. The ability to store auditory content in local 102 and remote 106 locations allows the auditory transition system 100 to process and reproduce a diverse variety of music, audible books, and spoken word content with mobile computing means, such as laptop computers, tablet computers, smartphones, and smart watches.

The processing of audible signals by the audio processor 104 allows intelligent auditory transitions to be created as completely original, or combinations of existing auditory transitions. The use of one or more controllers in the audio processor 104 can ensure auditory transitions can be evaluated, created, and implemented on-the-fly without delaying audio playback or having a seam between auditory segments. FIG. 2 is a block representation of a portion of an example auditory transition system 120 where a transition 122 spans a seam 124 between first 126 and second 128 songs of an auditory content stream 130. The auditory transition 122 can be characterized as an audible movement with varying auditory properties that seamlessly bridge a first segment (song 1) to a second segment (song 2).

An auditory seam 124 can be characterized as a pause in playback, drastic change in tempo, abrupt change in pitch, sudden change in volume, alteration of temporal relationships between fragments of audio data, and reversal of time series data. In other words, an auditory seam 124 can be any unpleasant change from the first song 126 to the second song 128. Accordingly, at least one system controller, such as a microprocessor of an audio processor 104, can create and implement the transition 122 that gradually changes tempo, pitch, volume, temporal relationships, and/or time series data to effectively make create a single stream of music instead of two distinct songs 126 and 128 separated by a seam 124.

As such, it can be appreciated that various embodiments of the present disclosure are directed to methods for creating and retrieving transitions 122 between two songs. The transition 122 between 2 songs is defined by 4 time points: the start of the transition 132 in song 1, the end of the transition 134 in song 1126, the start of the song transition 136 in song 2, and the end of the song transition 138 in song 2 . It is contemplated that these transition points can be selected by a user or by a system controller based on the content of the songs 126 and 128 as well as the time available for the transition 122.

When a transition 122 is recorded by a user for later use, the user specifies the 4 time points in 2 selected songs. The user can then manipulate the audio content between these time points in such a way that a combination of song 1 and 2 are playing at the same time. Each alterable aspect of audio content for each song 126 and 128 will vary at the different time points within a transition 122.

During playback of the transition 122, song 1 126 plays unaltered until it reaches the beginning of the transition 122. At that point, the audio content is altered as specified by the transition 122 for the duration of the transition 122. When the transition 122 ends, song 2 128 will be playing unaltered, which results in seamless playback for songs 1 and 2. The transition 122 may stored in machine readable format that may be retrieved when another user listens to the first song 126 followed by the second song 128. If an additional transition 140 exists from the second song 128 to a third song 142, it is possible to continue the seamless playback through the third song 142. This process can be extended to any number of songs to provide seamless playback of auditory content over short, or long, periods of time.

In accordance with some embodiments, an auditory transition system can create, save, retrieve, and play back auditory transitions between audio segments, such as songs or tracks. A system controller can predict user preferences in auditory transitions to make the movement between different audio segments more conducive to the user's preferences, such as tempo, pitch, and time series. An auditory transition system can share user-created custom auditory transitions over private, or public, networks. Such user-created auditory transitions can be collected, curated, and rated by other users.

An auditory transition may consist of one or more manipulations of data sets combined with the manipulation of data representing mutation to the auditory properties of the next auditory segment. It is noted that an auditory data set can represent the alteration of auditory properties over the duration of an audio recording. The creation or playing of auditory transitions does not limit a user's ability to listen to sound generated by audio recordings during playback. For example, a user can simultaneously listen to an audio segment while creating, or playing, one or more auditory transitions.

It is contemplated that at least one computing device, such as a laptop, tablet computer, or smartphone, may not have adequate audio capabilities to properly play an auditory segment or transition. In such situations, the computing device may pre-program and store in local memory auditory transitions between auditory segments. Pre-programmed auditory transitions may also be stored remotely and streamed to the user to allow audio and/or video playback by the user.

Although not limiting, an auditory transition may be defined as the combination of one or more auditory alterations, such as changes to tempo, changes to pitch, changes to volume on all frequencies of the audio spectrum, changes to volume at specific frequencies of the audio spectrum, changes in temporal relationships between fragments of audio data, and reversal of time series data. An auditory segment, transition, or recording, can be characterized as any information stored in computer readable format capable of representing auditory information, such as a waveform, byte data, or other time series data formats representing time-sampled data. Machine readable data may, in some embodiments, be stored on a separate network an connected on a privately enclosed, or public, network for future retrieval by one or more different users with network access.

Various embodiments characterize audio playback as any mechanism that converts data into measurable sound, audible to the user. During audio playback, one or more physical actions, such as touch, gesture, haptic, and eye motion, can be used to manipulate data representing auditory transitions. For instance, a physical action, like a swipe, by a user can result in the system controller selecting one of many different auditory transitions, such as increased or decreased pitch, tempo, or volume.

It is contemplated that the data representing transitions can be retrieved according to contexts or needs, such as, but not limited to, retrieving the highest ranked transition(s) between two arbitrary audio recordings, retrieving a specific users transition(s) between two arbitrary audio recordings, retrieving all transitions created by a particular user or list of users, retrieving all transitions with a specific label, retrieving all transitions from a particular song, retrieving all transitions to a particular song, retrieving all transitions created within a specific time period, retrieving all transitions that have been played a number of times within a specified range, and retrieving transitions using a combination of the methods listed above.

By sharing auditory transitions with others, the transitions can be ranked and voted upon with at least one qualitative judgment of the transitions being recorded for evaluation by the transition creating user. The qualitative judgment can be locally, or remotely stored in a machine readable format that can be evaluated as raw data, such as number of positive votes, or processed to provide suggestions to the user, such as adding a separate audio sample or changing pitch. The qualitative assessment of an auditory transition allows any number of users to collect and group transitions into collections as well as label, alter, favorite, and share transitions with others. Such collections can be stored locally and/or remotely in a machine readable format for future retrieval.

An auditory transition system may consists of any number of computing devices connected by a network or otherwise, such as peer-to-peer networks or direct wireless connections, which corresponds with any number of users being allowed to access and store data on those computing devices. The use of computing devices may further allow one or more algorithms to evaluate an auditory transition and make suggestions accordingly. As a non-limiting example, an algorithm may suggest a song, or song pair, that the transition may work well with, an alteration to the transition that would make it more audibly pleasing, or an alteration to the transition to conform to user, genre, or industry trends. An algorithm can be employed to suggest other transition authors, other collections, and other playlists based on various criteria.

An algorithm, in some embodiments, is utilized by a system controller to generate and store data representing links based on similarities of transition data, data about the authors of the transitions, their similarities to other transition authors and authors of transitions rated by the user, data about users who have rated the transition, data about the audio recording such as beats per minute, frequencies, chords, lyrics, data about the rating, or other meta-data pertaining to an audio recording, data about the rating, or other meta-data pertaining to a transition, and data about categorization or genre. It is noted that data associated with rating, authorship, qualitative analysis, and suggestions can be created by users or administrators of the system and may be be stored in a machine readable format locally and/or remotely. An algorithm may also generate and store similarities of song data such as beats per minute, frequencies, chords, lyrics, data about the authors of the audio recording, their similarities to other audio recording authors and authors of songs rated by the user, the number of transitions in and out of the audio recordings, the popularity of the audio recordings, and the categorization or genre of the audio recordings.

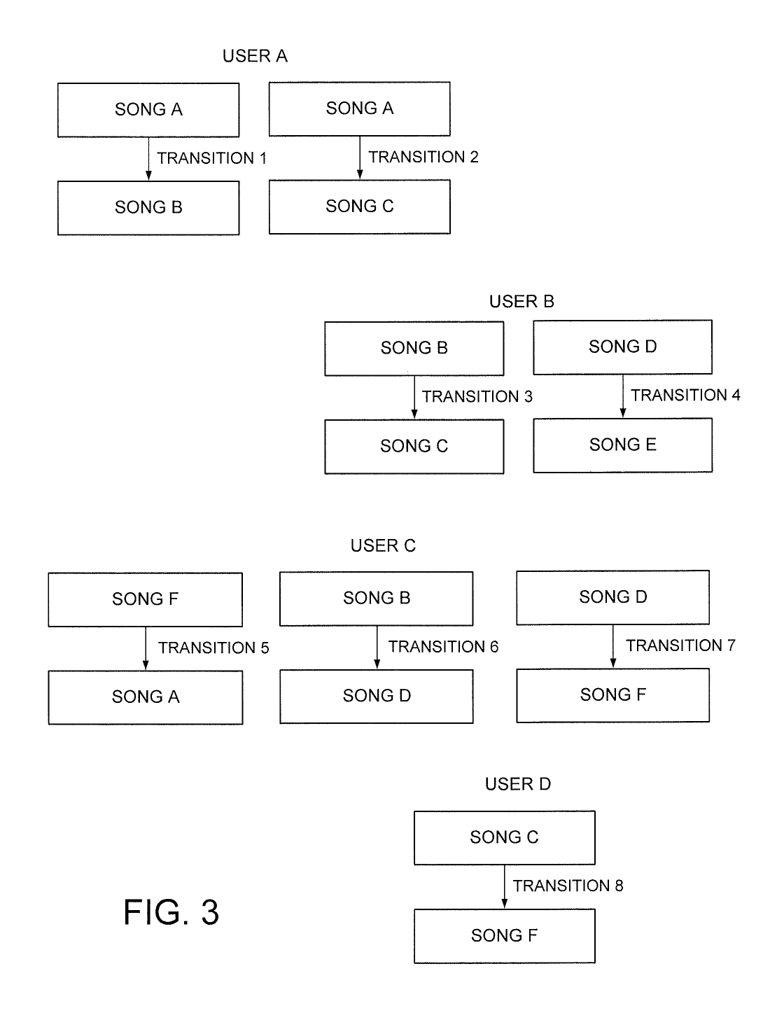

With the local and/or remote storage of transitions between particular auditory segments (songs), it is contemplated that a controller of an audio processor can access transitions of different users to create multiple different transition variations that can seamlessly bridge a first song to a second song. FIG. 3 depicts block representations of portions of an example auditory transition system constructed and operated in accordance with assorted embodiments. As shown, a first user (A) can create, or select from a predefined list, different first and second auditory transitions from song A to different songs (B & C). A second user (B) can create or select third and fourth auditory transitions to and from different songs (B, C, D, & E).

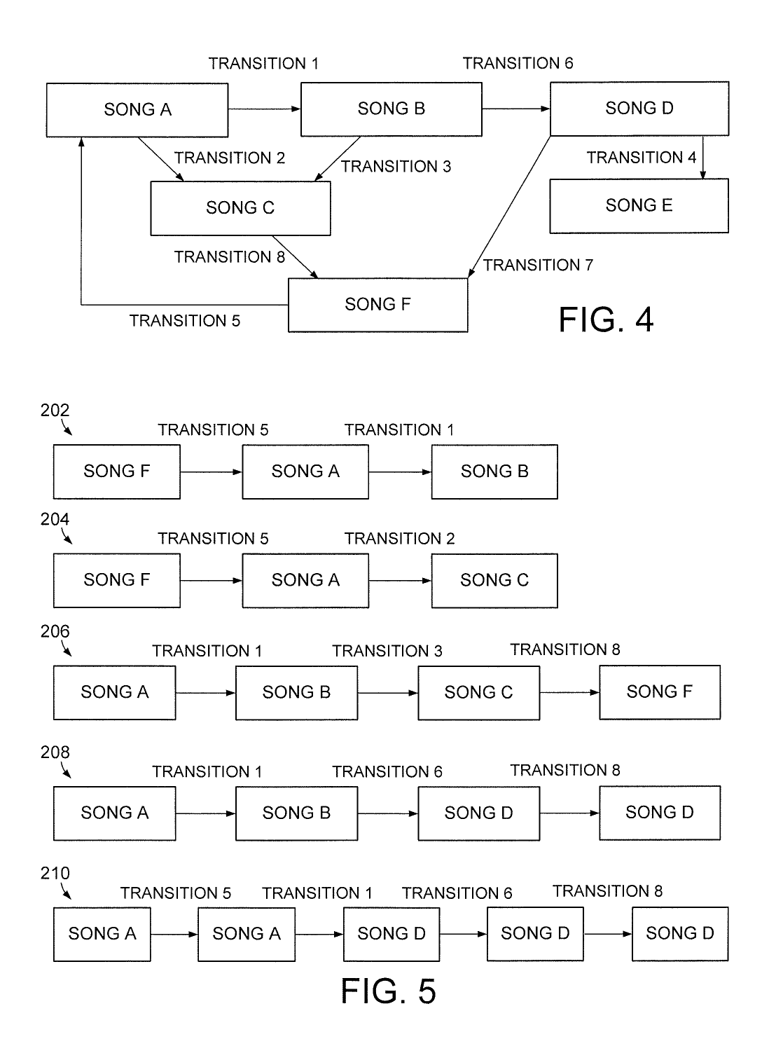

Fifth, sixth, and seventh transitions can respectively be generated or selected by a third user (C) to bridge different songs (A, B, D, & F). Meanwhile, a fourth user (D) can create or select an eighth transition from song C to song F. FIG. 4 illustrates a block representation of how the assorted transitions of FIG. 3 can be utilized in accordance with various embodiments to seamlessly play songs A-E by engaging different transitions. For example, song F can seamlessly be played after songs C or D by playing transition 7 or 8, respectively. In this way, a collection of different transitions can be manually selected by a user, or automatically by a system controller, to play a plurality of songs seamlessly.

In the non-limiting example where a transition exists between song B and song C, as well as between song B and song D, it is ambiguous which song will be played after song B. The choice of transition may be influenced by a prediction of which song (C or D) the user will prefer, which transition has a higher community-curated quality score, the dates the transitions and/or songs were created, which of those songs the user has heard before, the labels placed on those songs, or a combination of these factors.

FIG. 5 displays a block representation of possible traversals (sets) of songs seamlessly connected by auditory transitions. It can be appreciated how song F can initiate the first 202 and second 204 sets that result in different terminating songs (B or C). Similarly, sets 206 and 208 illustrate how four songs can seamlessly be played with different transitions. Set 208 shows how an auditory transition can be used to seamlessly replay song D, which bridges the ending of song D with the beginning of song D. In set 210, song A and song D are each replayed.

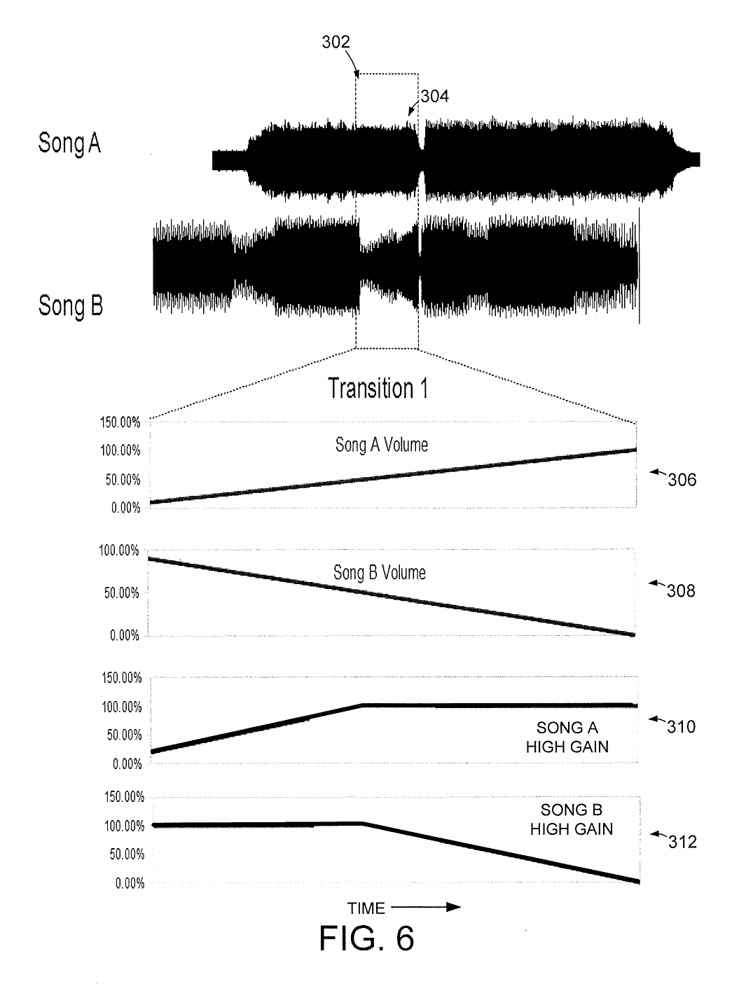

FIG. 6 depicts assorted portions of an example auditory transition system where song B is seamlessly transitioned to song A by the first transition. Each song has a transition region 302 that prevents a seam 304 from disrupting the flow, tempo, and pitch of the stream of music. As displayed by graphs 306, 308, 310, and 312, the first transition linearly increases the volume of song A (306) while linearly decreasing the volume of song B (308). Such linear adjustment ensures the transition is imperceptible by a user. However, other transition adjustments can be utilized. For instance, the gain (310) of song A can be increased to a plateau while the gain (312) of song B is decreased from a plateau.

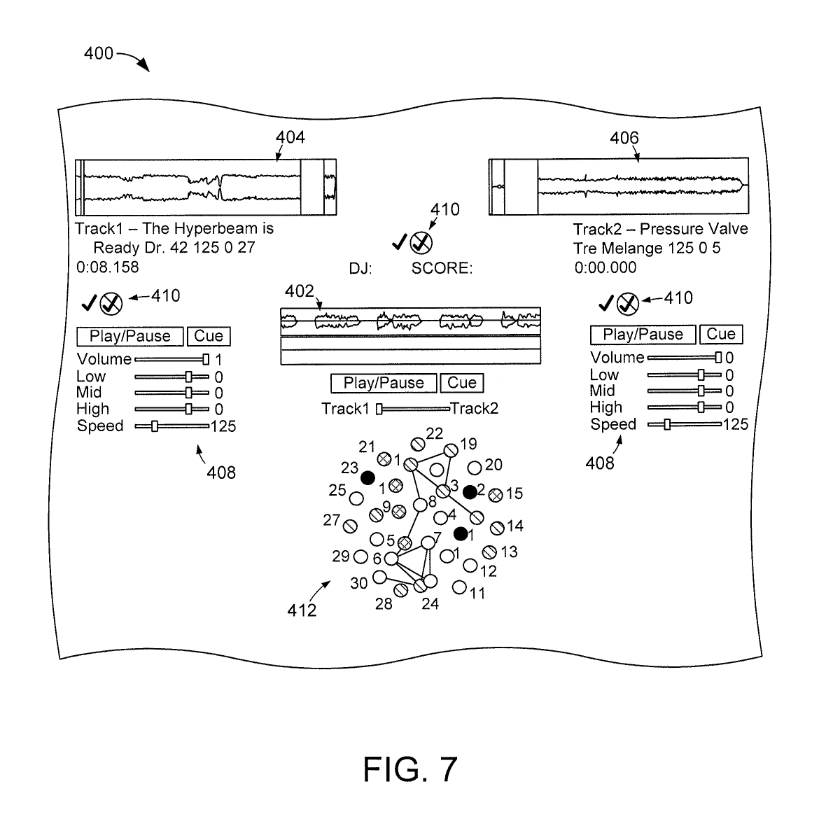

It is noted that the example transition of FIG. 6 illustrates two different audio characteristics being concurrently altered to provide a seamless bridge between songs. Any number of other, and additional, audio characteristics can be independently or collectively changed over time, such as pitch tempo, and temporal relationships. FIG. 7 shows an example console 400 that is arranged in accordance with various embodiments to allow a user to create, select, and activate one or more auditory transitions 402. The console 400 has graphical illustrations of different first 404 and second 406 auditory segments. The graphical representation can aid the user in selecting an auditory transition 402 that is similar to portions of either, or both, segments 404/406. The graphical representation of the transition 402 may further allow the user to intelligently select starting and ending points for the transition 402.

The console 400 provides a number of controls 408 that can be used to newly create, or alter an existing, auditory transition. The controls 408 allow the user to change at least the gain on different frequency ranges (low, mid, high) as well as the volume and tempo (speed) of playback. It is contemplated that other characteristics, like pitch, stereo fade, and the addition of special effects, can also be incorporated into the controls 408.

When a new or altered auditory transition has been reviewed, the user can comment and/or vote with a qualitative section 410 of the console 400. For instance, when listening to audio, users can “vote up” or “vote down” the current song. This information is stored and may be used to predict a users preference for others songs or other users. The user may also up “vote up” or “vote down” an auditory transition 402 when transitioning between songs. This information is stored and may be used to predict a user's preference for another user's auditory transition 402. The ability to comment and vote on auditory transitions 402 provides feedback to others and allows for the collection of pre-screened transitions 402 for efficient later retrieval.

Qualitative analysis of auditory transitions 402 can also allow one or more algorithms to process and predict the preferences of a user. Region 412 conveys a graphical representation of interconnections between separate audio segments and special effects that are connected to provide a sample auditory transition 402. That is, region 412 can visually illustrate how an algorithm analyzes and combines various auditory elements and characteristics to arrive at a predicted auditory transition 402. Region 412 may also illustrate the analysis of an auditory transition 402 currently being played or that is cued, which educates the user about the mechanics and characteristics of auditory transitions 402 that are audibly pleasing.

Through the various embodiments of the present disclosure, an auditory transition system allows for the sharing, collaborating, retrieving, editing, and playing back of auditory transitions between sound recordings. The auditory transition system allows for a user to create unique auditory transitions and store the data representing those transitions remotely both for future playback and editing. Analysis of the sound recordings and/or the network of data connections between sound recordings allows for seamless continual playback for the user. Users can initiate playback of other users collections of sound recordings such that they have the opportunity to “vote up” or “vote down” not only sound recordings, but transitions designed by other users, allowing for community-curated, continuous playback music streams with the “best” transitions.

Curation can entail the labeling of audio recordings with descriptive terms such as musical genre. Users could also listen to just a specific user's transitions and selected songs as well. Users could also listen to songs with a particular label(s), and only transitions between songs with that label(s). A user could listen to a series of audio transition created by different users at different times. A user's voting history may be used to predict which songs and which transitions to play for that user. The described techniques can be used in conjunction with a variety of devices, including handheld devices that include touch-screen interfaces, such as desktop computers, tablet computers, notebook computers, handheld computers, personal digital assistants, media players, mobile telephones, midi devices, and combinations thereof

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

What is claimed is:

1. An apparatus comprising an audio processor positioned between a memory and a speaker, the audio processor configured to construct a data stream that seamlessly transitions between first and second audio segments by inserting an auditory transition between the respective audio segments.

2. The apparatus of claim 1, wherein the audio processor is a microprocessor locally positioned in a computing device.

3. The apparatus of claim 1, wherein the speaker is physically connected to a computing device.

4. The apparatus of claim 1, wherein the audio processor comprises an amplifier.

5. The apparatus of claim 1, wherein the memory is physically located in a common computing device with the audio processor.

6. The apparatus of claim 1, wherein the memory is physically located at two or more remote locations and connected to the audio processor via a network.

7. The apparatus of claim 1, wherein the auditory transition comprises gradual alterations of at least two auditory characteristics over time.

8. The apparatus of claim 1, wherein the auditory transition is activated by the audio processor to play through the speaker concurrently with the first audio segment before playing concurrently with the second audio segment.

9. The apparatus of claim 1, wherein the auditory transition comprises of audible frequencies that bridge at least a tempo, pitch, and volume of the first audio segment to the second audio segment without an audible disruption.

10. A method comprising:
connecting an audio processor between a memory and a speaker;
inserting a first auditory transition between first and second audio segments with the audio processor; and
playing the first and second audio segments continuously without an audible seam.

11. The method of claim 10, wherein the first auditory transition is selected from a collection of multiple different auditory transitions by a user.

12. The method of claim 10, wherein an algorithm executed by the audio processor selects the first auditory transition from a collection of multiple different auditory transitions.

13. The method of claim 10, wherein the first auditory transition is altered by a user prior to being inserted between the first and second audio segments.

14. The method of claim 10, wherein a second auditory transition is played by the audio processor to seamlessly bridge the second audio segment to a third audio segment, the first, second, and third audio segments being different and the first and second auditory transitions being different.

15. The method of claim 10, wherein the audio processor suggests a second auditory transition prior to the user selecting the first auditory transition for insertion between the first and second audio segments.

16. A method comprising:
connecting an audio processor between a memory and a speaker;
creating an auditory transition with the audio processor;
inserting the auditory transition between first and second audio segments with the audio processor; and
playing the first and second audio segments continuously without an audible seam

17. The method of claim 1, wherein the auditory transition is altered by a user prior to insertion between the first and second audio segments.

18. The method of claim 1, wherein the auditory transition is assigned to the first and second audio segments by the audio processor.

19. The method of claim 1, wherein the auditory transition comprises a linear shift in temporal relationship from the first audio segment to the second audio segment.

20. The method of claim 1, wherein the auditory transition is selected by the audio processor after a user has voted approval of the auditory transition.
